(19) United States
(12) Patent Application Publication
(10) Pub. No.: US 2013/0335664 A1
(43) Pub. Date: Dec. 19, 2013

(54) DISPLAY PANEL AND METHOD OF MANUFACTURING THE SAME

(71) Applicant: SAMSUNG DISPLAY CO., LTD., Yongin-City (KR)

(72) Inventors: Seung-Bo SHIM, Asan-si (KR); Yang-Ho JUNG, Seoul (KR); Jin-Ho JU, Seoul (KR); Da-Woon KIM, Seoul (KR); Jun-Gi KIM, Seoul (KR)

(73) Assignee: SAMSUNG DISPLAY CO., LTD., Yongin-City (KR)

(21) Appl. No.: 13/733,289

(22) Filed: Jan. 3, 2013

(30) Foreign Application Priority Data
Jun. 14, 2012 (KR) 10-2012-0063596

(51) Int. Cl. G02F 1/1339

(52) U.S. Cl. CPC G02F 1/1339
USPC 349/43; 438/30

(57) ABSTRACT

A display panel includes a substrate, a thin film transistor on the substrate, a first electrode electrically connected to the thin film transistor, a first insulation layer covering the first electrode, an image displaying layer disposed on the first insulation layer, a second insulation layer disposed on the image displaying layer, a second electrode disposed on the second insulation layer and insulated from the first electrode, and a protecting layer disposed on the second electrode. The protecting layer surrounds a portion of an upper surface and a side surface of the image displaying layer. The protecting layer includes a light curable material.

This application claims priority to Korean Patent Application No. 10-2012-0063596, filed on Jun. 14, 2012, and all the benefits accruing therefrom under 35 U.S.C. §119, the contents of which are incorporated by reference herein in its entirety.

### BACKGROUND

1. Field

Exemplary embodiments of the invention relate to a display panel and a method of manufacturing the display panel.

More particularly, exemplary embodiments of the invention relate to a display panel having only one substrate, and a method of manufacturing the display panel.

2. Description of the Related Art

In a touch display apparatus, a liquid display apparatus applies a voltage to a specific molecular arrangement to change the molecular arrangement. The liquid display apparatus displays an image using changes in an optical property (for example, birefringence, rotatory polarization, dichroism and light scattering) of a liquid crystal cell therein, according to the changes of the molecular arrangement.

Generally, a display panel of the liquid display apparatus includes a liquid crystal layer between two substrates. The liquid crystal layer is formed by injecting liquid crystal between the two substrates. However, the display panel of the liquid display apparatus, which includes the two substrates, undesirably increases a thickness and weight of the liquid display apparatus, and may incur a high manufacturing cost.

In addition, a manufacturing process of the display panel having only one substrate may be complex.

In addition, a top surface of the display panel may be swollen or deformed during a heat curing process of the manufacturing process. Therefore, there remains a need for an improved display panel.

### SUMMARY

One or more exemplary embodiment of the invention provides a display panel having only one substrate, where a top surface of the display panel is stable during a heat curing process of a manufacturing process.

One or more exemplary embodiment of the invention also provides a method of manufacturing the display panel.

According to an exemplary embodiment of the invention, a display panel includes a substrate including a plurality of pixel areas, a thin film transistor on the substrate, a first electrode electrically connected to the thin film transistor, a first insulation layer covering the first electrode, an image displaying layer disposed on the first insulation layer, a second insulation layer disposed on the image displaying layer, a second electrode disposed on the second insulation layer and insulated from the first electrode, and a protecting layer disposed on the second electrode. The protecting layer surrounds a portion of an upper and a side surface of the image displaying layer. The protecting layer includes a light curable material.

In an exemplary embodiment, the first insulation layer and the second insulation layer may include an inorganic insulating material.

In an exemplary embodiment, the display panel may further include a sealing part disposed between adjacent pixel areas. The sealing part may contact the first insulation layer, the side surface of the image displaying layer, and a side surface of the protecting layer.

In an exemplary embodiment, the display panel may further include a signal line connected to the thin film transistor, and a black matrix overlapping the signal line and blocking light. The sealing part may overlap the black matrix.

In an exemplary embodiment, the image displaying layer may include a liquid crystal layer including liquid crystal, and an alignment layer. The alignment layer may be disposed between the first insulation layer and the liquid crystal layer, and between the second insulation layer and the liquid crystal layer.

In an exemplary embodiment, the display panel may further include an upper polarizer disposed on the protecting layer and a lower polarizer disposed under the substrate. The upper polarizer may contact the protecting layer.

According to another exemplary embodiment of the invention, a method of manufacturing a display panel includes providing a thin film transistor on a substrate and providing a first insulation layer on the thin film transistor, providing a sacrificial layer on the first insulation layer by coating a first photoresist composition, providing a second insulation layer on the sacrificial layer, providing a protecting layer on the second insulation layer by coating a second photoresist composition, exposing the protecting layer and the sacrificial layer to light, removing the sacrificial layer using a developer to form a space, and providing an image displaying layer in the space.

In an exemplary embodiment, the light may have a power of about 300 millijoules (mJ) to about 3 joules (J).

In an exemplary embodiment, the light may have a wavelength of more than about 365 nanometers (nm).

In an exemplary embodiment, the developer may include tetramethylammonium hydroxide (“TMAH”) or potassium hydroxide (“KOH”).

In an exemplary embodiment, the developer may include more than about 90% of water, and less than about 10% of the TMAH or the KOH, respectively.

In an exemplary embodiment, the removing the sacrificial layer may be performed at a temperature of about 23 degree Celsius (° C.) to about 26° C.

In an exemplary embodiment, the method may further include heating the sacrificial layer in a first thermal curing process. The first thermal curing process is performed before the removing the sacrificial layer, and at a temperature of about 80° C. to about 180° C.

In an exemplary embodiment, the method may further include heating the protecting layer in a second thermal curing process. The second thermal curing process may be performed after the removing the sacrificial layer, and at a temperature of about 180° C. to about 300° C.

In an exemplary embodiment, the method may further include providing a first electrode on the substrate before the providing the first insulation layer, and providing a second electrode on the second insulation layer before the providing the protecting layer.

In an exemplary embodiment, the method may further include providing a developer inlet before the removing the sacrificial layer. In forming the developer inlet, an exposed portion of the second insulation layer may be etched using the protecting layer as a mask, to expose the sacrificial layer.

In an exemplary embodiment, the first photoresist composition may include a positive photoresist.

In an exemplary embodiment, the second photoresist composition may include a negative photoresist.

In an exemplary embodiment, the substrate includes a plurality of pixel areas which display an image. In the providing the sacrificial layer, the sacrificial layer may correspond to the pixel areas. The sacrificial layer of a pixel area may be spaced apart from a sacrificial layer of an adjacent pixel area.

In an exemplary embodiment, the providing the image displaying layer may include forming an alignment film inside of the space, and forming a liquid crystal layer by injecting liquid crystal into the space and on the alignment film.

According to one or more exemplary embodiment of the invention, a display panel includes a liquid crystal layer disposed in a tunnel-shaped cavity, so that an amount of liquid crystal and a number of substrates used in the display panel may be decreased.

In addition, a sacrificing layer and a protecting layer are used to define the tunnel-shaped cavity. Since the sacrificing layer includes a positive photoresist, and the protecting layer includes a negative photoresist, the process of manufacturing the display panel may be simplified.

In addition, a top surface of the protecting layer is exposed during a heat curing process, so that an upper surface of the display panel may be planarized.

### BRIEF DESCRIPTION OF THE DRAWINGS

The above and other features of the invention will become more apparent by describing in detail exemplary embodiments thereof with reference to the accompanying drawings, in which:

FIG. 1 is a plan view illustrating an exemplary embodiment of a display panel according to the invention;

FIG. 2 is a cross-sectional view taken along line I-I′ of FIG. 1;

FIG. 3 is a cross-sectional view taken along line II-II of FIG. 1;

FIG. 4 is flowchart illustrating an exemplary embodiment of a method of manufacturing a display apparatus according to the invention;

FIG. 5A to 5J are cross-sectional views of an exemplary embodiment of a display panel to illustrate the method of FIG. 4.

### DETAILED DESCRIPTION

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “under” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

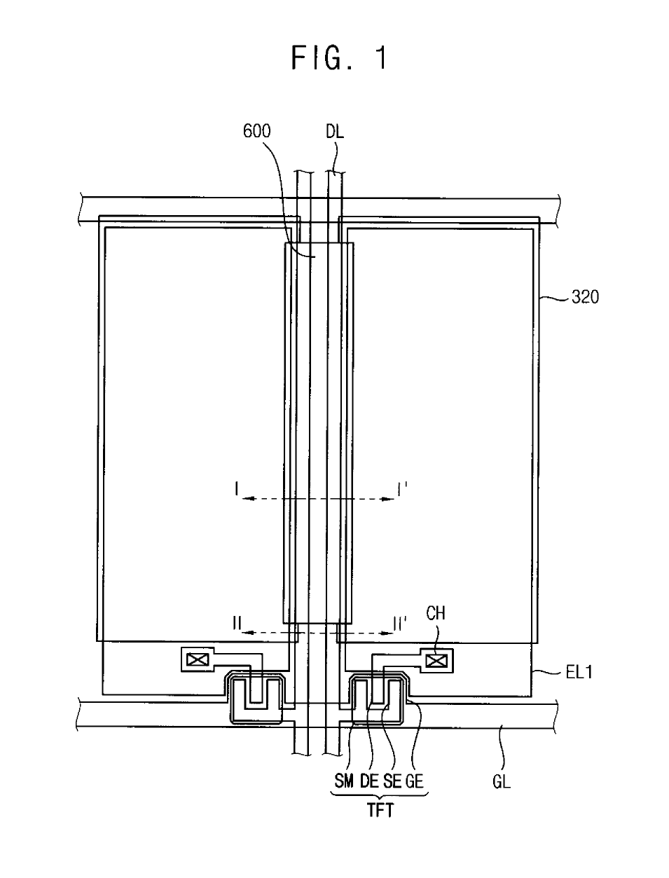

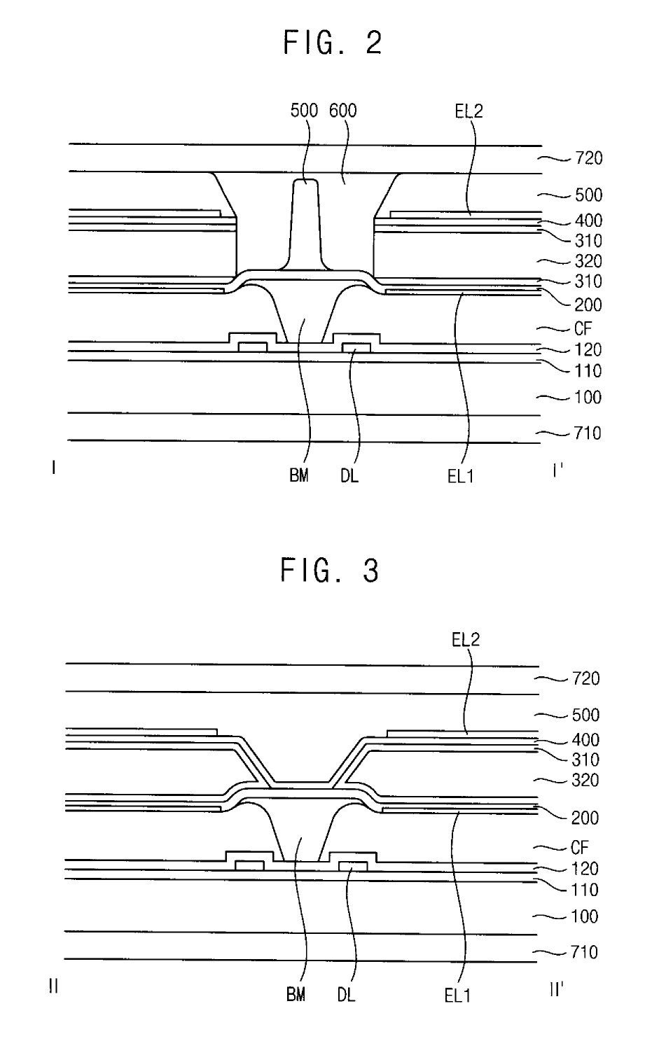

FIG. 1 is a plan view illustrating an exemplary embodiment of a display panel according to the invention. FIG. 2 is a cross-sectional view taken along line I-I′ of FIG. 1.

Referring to FIGS. 1 to 2, the display panel includes a substrate 100, a thin film transistor TFT, a gate insulation layer 110, a data insulation layer 120, a color filter CF, a black matrix BM, a first insulation layer 200, an alignment film 310, a liquid crystal layer 320, a second insulation layer 400, a protecting layer 500, a sealing part 600, a lower polarizer 710 and an upper polarizer 720.

The substrate 100 may be a transparent insulation substrate. The substrate 100 includes a pixel area defined thereon, and may have a plurality of pixel areas defined thereon. A pixel area displays an image thereon. Although only two adjacent pixel areas are illustrated in the figures, the exemplary embodiment of the display panel according to the invention includes a plurality of pixels in a plurality of pixel areas. The plurality of pixel areas is arrayed in a matrix structure in the plan view, having a plurality of pixel rows and pixel columns. The pixel areas may have same structure each other, so that only one pixel area will be described hereinafter. Although the pixel area has a substantially rectangular shape in the figures, the pixel area may have various shapes in modifications thereof. In one exemplary embodiment, for example, the pixel area may have V-shape or Z-shape.

A gate pattern including a gate electrode GE and a gate line GL is disposed on the substrate 100. The gate line GL is electrically connected to the gate electrode GE. The display panel may include a plurality of gate lines GL and/or a plurality of gate electrodes GE. The gate electrode GE may be continuous with and protrude from the gate line GL to form a single, unitary indivisible member.

The gate insulation layer 110 is disposed on the substrate 100 and the gate pattern, so that the gate insulation layer 110 insulates the gate pattern from other elements of the display panel.

A semiconductor pattern SM is on the gate insulation layer 110. The semiconductor pattern SM overlaps the gate electrode GE.

A data pattern including a data line DL, a source electrode SE and a drain electrode DE is disposed on the gate insulation layer 110 and the semiconductor pattern SM. The source electrode SE overlaps the semiconductor pattern SM, and is electrically connected to the data line DL. The display panel may include a plurality of data lines DL, a plurality of source electrodes SE and/or a plurality of drain electrodes DE. The source electrode SE may be continuous with and protrude from the data line DL to form a single, unitary indivisible member.

The drain electrode DE is spaced apart from the source electrode SE and overlaps the semiconductor pattern SM. The semiconductor pattern SM forms a conductive channel between the source electrode SE and the drain electrode DE.

The gate electrode GE, the source electrode SE, the drain electrode DE and the semiconductor pattern SM form the thin film transistor TFT.

The data insulation layer 120 is disposed on the gate insulation layer 110 and the data pattern. The data insulation layer 120 insulates the data pattern from other elements of the display panel.

The color filter CF is disposed on the data insulation layer 120. The color filter CF supplies color to a light passing therethrough and toward the liquid crystal layer 320. The color filter CF may include a red color filter, a green color filter and blue color filter, but is not limited thereto or thereby. The color filter CF corresponds to the pixel area. The display panel may include a plurality of color filters CF respectively disposed in a plurality of pixel areas. Adjacent color filters CF of the plurality of color filters may have different colors from each other, but are not limited thereto or thereby. In the exemplary embodiment, a color filter CF is spaced apart from an adjacent color filter CF in a boundary of the pixel area. In addition, a color filter CF may overlap an adjacent color filter CF in the boundary of the pixel area.

The black matrix BM is disposed on the data insulation layer 120 and the color filter CF. The black matrix BM overlaps the gate pattern and/or the data pattern, and blocks light.

A contact hole CH extends through thicknesses of the data insulation layer 120 and the color filter CF, or through the data insulation layer 120 and the black matrix BM, to expose the drain electrode DE.

A first electrode EL1 is disposed on the color filter CF. The first electrode EL1 covers substantially an entire of the pixel area, such that a portion of the pixel area may be exposed by the first electrode EL1. The first electrode EL1 is electrically connected to the drain electrode DE through the contact hole CH. In a plan view, the first electrode EL1 may have any of a number of shapes, such as having approximately a rectangular shape, a shape having a plurality of stems and a plurality of branches extending from the stems, etc. In addition, the first electrode EL1 may have a slit pattern. The first electrode EL1 may include a transparent conductive material, such as indium tin oxide (“ITO”), indium zinc oxide (“IZO”), etc.

The first insulation layer 200 is disposed on the color filter CF and the first electrode EL1. The first insulation layer 200 insulates the first electrode EL1 from other elements of the display panel. The first insulation layer 200 may include an inorganic insulating material such as silicon oxide (SiOx) and silicon nitride (SiNx).

The liquid crystal layer 320 is disposed on the first insulation layer 200, and corresponds to the pixel area. The liquid crystal layer 320 includes liquid crystal molecules having optical anisotropy. The liquid crystal molecules are driven by an electric field, so that an image is displayed on the display panel by passing light through the liquid crystal layer 320 or by blocking the light so as to not pass through the liquid crystal layer 320.

Although the exemplary embodiment of the display panel includes the liquid crystal layer 320, the display panel may include an alternative image displaying layer to display an image instead of the liquid crystal layer 320. In one exemplary embodiment, for example, the image displaying layer may be an electrophoresis layer. The electrophoresis layer may include an insulating medium and charge carriers. The insulating medium may be a dispersion medium of the dispersed charge carriers. The charge carriers may be diffused in the insulating medium to generate a charged interface with respect to the insulating medium. The charge carriers move under application of the electric field, so that an image is displayed by passing light through the electrophoresis layer or by blocking light so as to no pass through the electrophoresis layer.

The second insulation layer 400 is disposed on the liquid crystal layer 320. The second insulation layer 400 includes an inorganic insulating material such as silicon oxide (SiOx) and silicon nitride (SiNx). A second electrode EL2 is disposed on the second insulation layer 400. The second electrode EL2 may include a transparent conductive material, such as ITO, IZO, etc.

The alignment film 310 is disposed between the liquid crystal layer 320 and the first insulation layer 200, and between the liquid crystal layer 320 and the second insulation layer 400. The alignment film 310 pre-tilts the liquid crystal molecules of the liquid crystal layer 320. The alignment film 310 may be omitted according to a type of the liquid crystal layer 320 and/or according to structures of the first and/or second electrodes EL1 and EL2. In one exemplary embodiment, for example, when the first and second electrodes EL1 and EL2 have a specific pattern, the alignment film 310 may be omitted. In addition, when the liquid crystal layer 320 includes a reactive-mesogen layer, the alignment film 310 may be omitted. The alignment layer 310 respectively between the liquid crystal layer 320, and the first and second insulation layers 200 and 400, may be a single, unitary, indivisible layer, but is not limited thereto or thereby.

The protecting layer 500 is disposed on the second insulation layer 400 and the second electrode EL2. The protecting layer 500 includes a negative photoresist. The negative photoresist may include an organic material including acrylic resin and the like. In one exemplary embodiment, for example, the protecting layer 500 may include negative acryl photoresist. In addition, the protecting layer 500 may further include a light curable material and/or a thermal curable material.

The liquid crystal layer 320, the alignment film 310, the second insulation layer 400 and the protecting layer 500 has an opening in an area adjacent to the pixel area to expose a portion of the first insulation layer 200. In one exemplary embodiment, for example, the opening overlaps the black matrix BM and the late line DL.

The sealing part 600 seals or encloses the opening. The sealing part 600 may include an organic material, such as a sealant. As illustrated in FIG. 1 and FIG. 2, the sealing part 600 is disposed between the adjacent pixel areas in the plan view. The sealing part 600 may be disposed for every two pixels, such as in one-to-two correspondence with the pixels. The display panel may further include an upper protecting layer (not shown) on the protecting layer 500 and the sealing part 600. The upper protecting layer protects top surface of the display panel. The upper protecting layer may include an inorganic insulating material such as silicon oxide (SiOx) and silicon nitride (SiNx).

The lower polarizer 710 is disposed under the substrate 100. In one exemplary embodiment, the lower polarizer 710 may include a lower polarizing layer, and an attachable-detachable layer disposed between the lower polarizing layer and the substrate 100.

The lower polarizing layer changes light passing through the lower polarizing layer to polarized light. The lower polarizing layer may include a phase difference layer (not shown in figures) changing a phase of the light, and a protecting film (not shown in figures).

The attachable-detachable layer is disposed between the lower polarizing layer and the substrate 100, so that the lower polarizing layer may be attached to the substrate 100.

The upper polarizer 720 is disposed on the protecting layer 500. The upper polarizer 720 may include an upper polarizing layer, and an attachable-detachable layer disposed between the upper polarizing layer and the protecting layer 500.

The upper polarizing layer changes light passing through the upper polarizing layer to polarized light. The upper polarizing layer may include phase difference layer (not shown in figures) changing a phase of the light, and a protecting film (not shown in figures).

The attachable-detachable layer is disposed between the upper polarizing layer and the protecting layer 500, so that the upper polarizing layer may be attached to the protecting layer 500. In an exemplary embodiment of manufacturing the display panel, as the upper polarizer 720 is attached to the protecting layer 500, the sealing part 600 may be pressed, so that the sealing part 600 may be deformed to coincide to a surface of the protecting layer 500. That is, upper surfaces of the sealing part 600 and the protecting part 500 may be coplanar with each other. Thus, the upper polarizer 720 may be attached to the protecting layer 500 such that there is no space between the upper polarizer 720, the sealing part 600 and the protecting layer 500.

FIG. 3 is a cross-sectional view taken along line II-IF of FIG. 1. FIG. 3 is a cross-sectional view illustrating a portion of the display panel of FIG. 1, which is adjacent the pixel area and adjacent to the opening. Thus, only elements different from the display panel of FIG. 1 will be explained.

The opening may be defined by the first insulation layer 200, the liquid crystal layer 320, the alignment film 310, the second insulation layer 400, the protecting layer 500 and the upper polarizer 720. Referring to FIG. 3, the liquid crystal layer 320 includes portions which are spaced apart from each other in an area between adjacent pixels, such as at the boundary of pixel areas. The second insulation layer 400 and the protecting layer 500 are disposed in the area between the adjacent pixels. A top surface of the protecting layer 500 is substantially flat, and the protecting layer 500 surrounds a portion of top and side surfaces of the liquid crystal layer 320. Thus, in an exemplary embodiment of manufacturing the display panel, the protecting layer 500 may be used to form a cavity before injection of the liquid crystal layer 320.

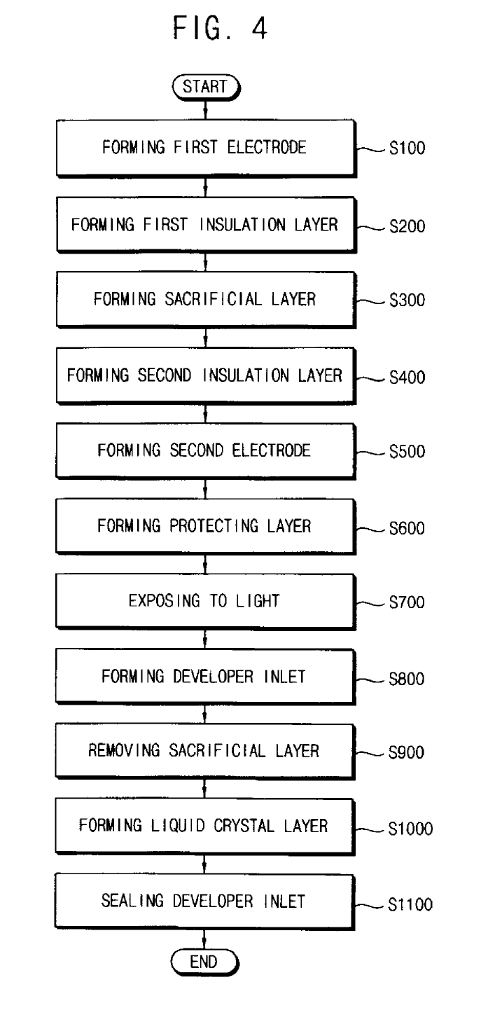

FIG. 4 is flowchart illustrating an exemplary embodiment of a method of manufacturing a display apparatus according to the invention.

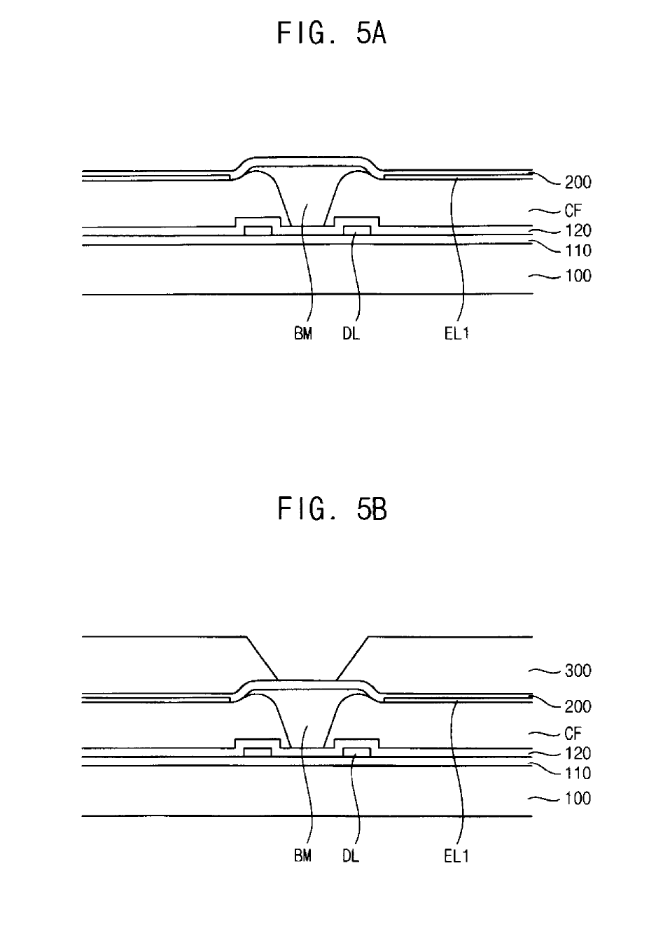

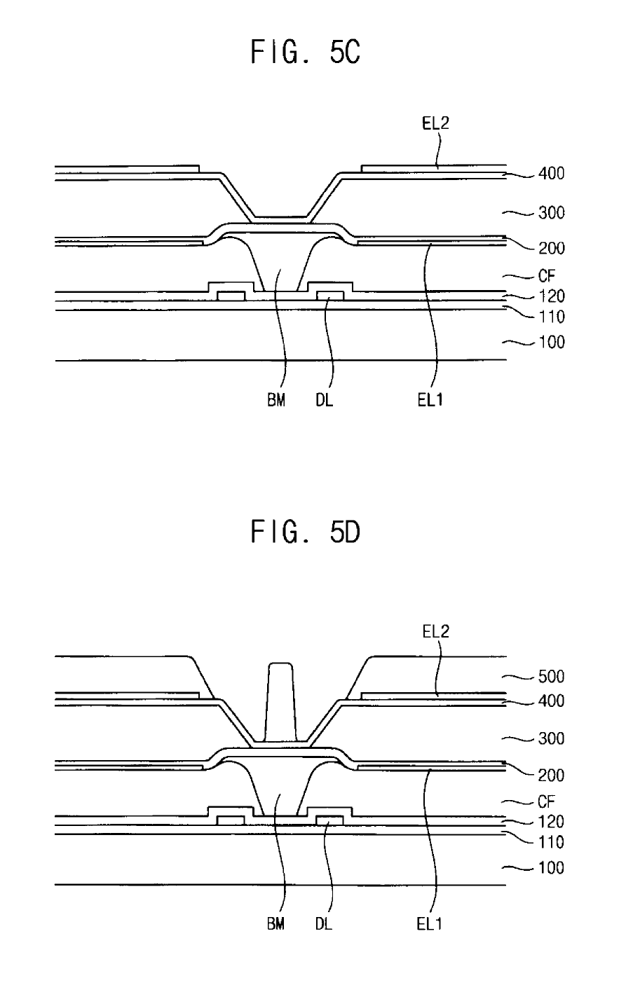

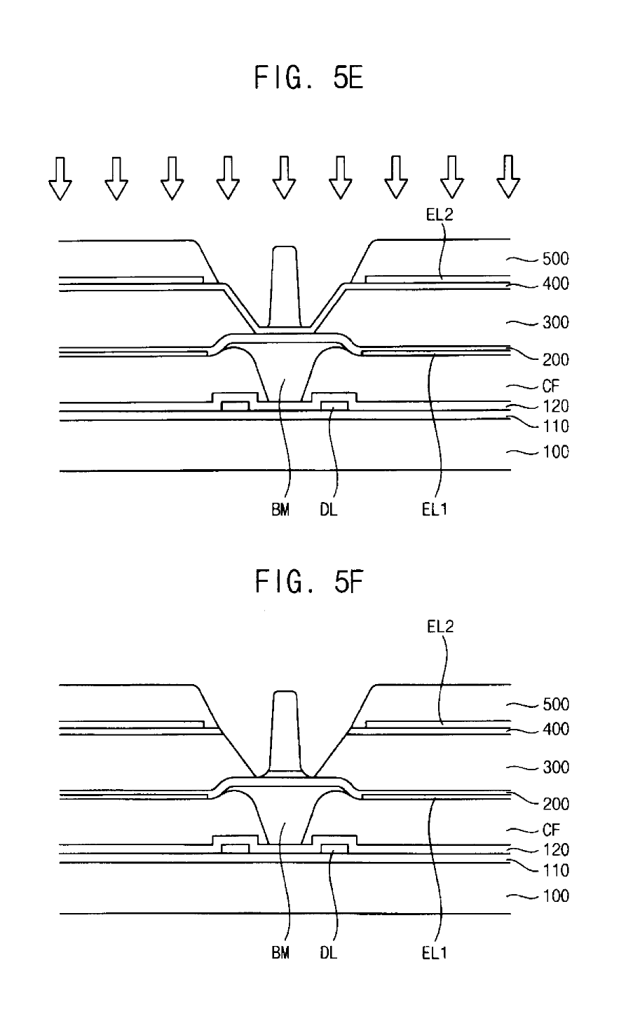

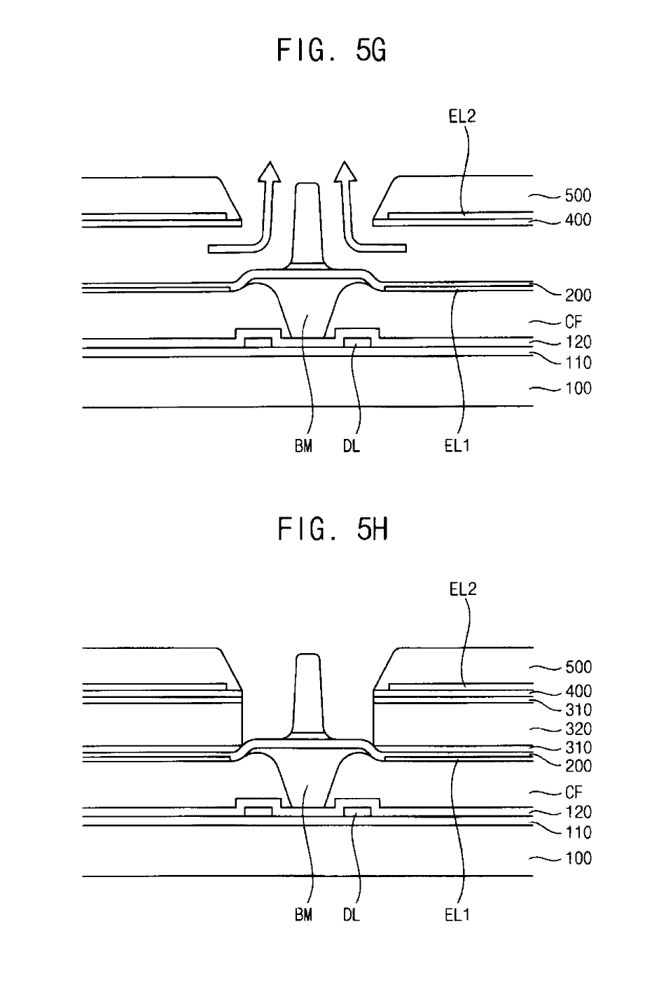

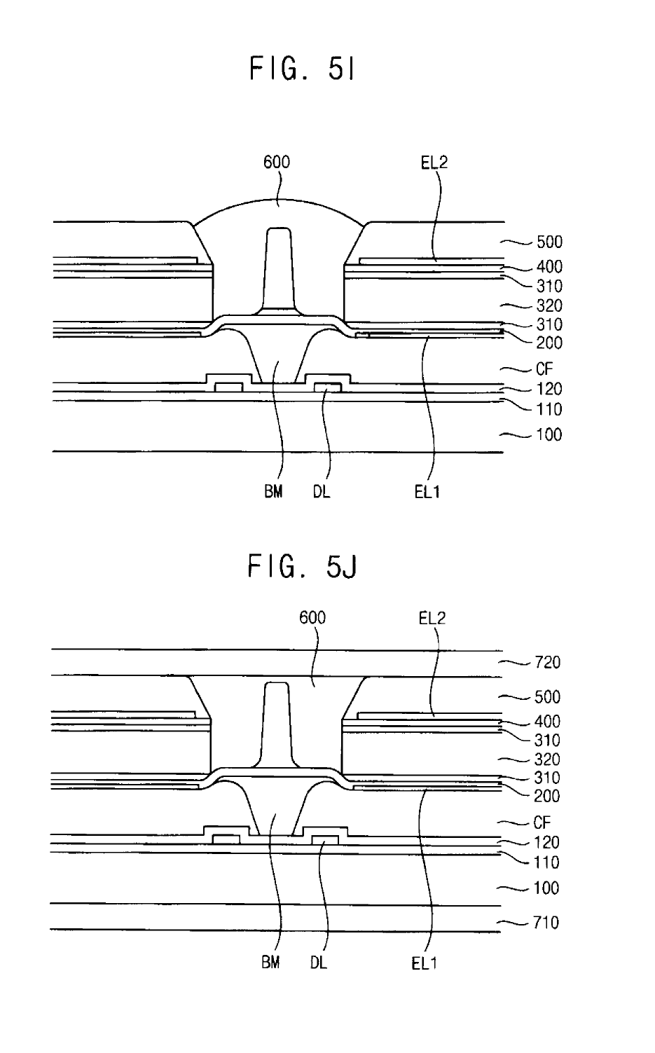

Referring to FIG. 4, the method includes forming (e.g., providing) a first electrode (S100), forming a first insulation layer (S200), forming a sacrificial layer (S300), forming a second insulation layer (S400), forming a second electrode (S500), forming a protecting layer (S600), exposing the second insulation layer and the protecting layer to light (S700), forming a developer inlet (S800), removing the sacrificial layer (S900), forming a liquid crystal layer (S1000) and sealing the developer inlet (S1100). Detailed explanation will be described in FIGS. 5A to 5J.

FIG. 5A to 5J are cross-sectional views of an exemplary embodiment of a display panel, to illustrate the method of FIG. 4.

Referring to FIG. 5A, forming (e.g., providing) a first electrode (S100) and forming a first insulation layer (S200) will be explained, hereinafter.

Before forming the first electrode (S100), a substrate 100, a gate insulation layer 110, a data insulation layer 120, a color filter CF and a black matrix BM may be provided.

A gate pattern including a gate electrode (refer to GE of FIG. 1) and a gate line (refer to GL of FIG. 1) are formed on the substrate 100. The gate pattern may be formed by disposing a first conductive layer on the substrate 100 and pattering the first conductive layer such as by using photo lithography, but is not limited thereto or thereby.

The gate insulation layer 110 is formed on the substrate 100 and on the gate pattern. The gate insulation layer 110 covers the gate pattern and insulates the gate pattern from other elements of the display panel.

A semiconductor pattern (refer to SM of FIG. 1) is formed on the gate insulation layer 110. The semiconductor pattern overlaps the gate electrode (refer to GE of FIG. 1).

A data pattern including a data line DL, and a source and drain electrode (refer to SE and DE of FIG. 1) is formed on the gate insulation layer 110 and on the semiconductor pattern. The data pattern may be formed by disposing a second conductive layer on the gate insulation layer 110 and pattering the second conductive layer such as by using photo lithography, but is not limited thereto or thereby.

The drain electrode is spaced apart from the source electrode on the semiconductor pattern, such that a portion of the semiconductor pattern is exposed between the drain and source electrodes DE and SE. The semiconductor pattern forms a conductive channel between the source electrode and the drain electrode.

The gate electrode, the source electrode, the drain electrode and the semiconductor pattern form the thin film transistor (refer to TFT of FIG. 1).

The data insulation layer 120 is formed on the gate insulation layer 110. The color filter CF is formed on the data insulation layer 120. The color filter CF may include a red color filter, a green color filter and a blue color filter, but is not limited thereto or thereby. The color filter CF may include an organic polymeric material. The color filter CF may be formed by photo lithography such as using photosensitive polymeric material. Additionally or alternatively, the color filter CF may be formed by other methods, such as an inkjet method, etc.

The black matrix BM is formed on the data insulation layer 120 and on the color filter CF. The black matrix BM overlaps the gate pattern and/or the data pattern.

Although an exemplary embodiment of the display panel has the color filter CF and the black matrix BM disposed under the liquid crystal layer, the invention is not limited thereto. In an alternative exemplary embodiment of a display panel, for example the color filter CF and the black matrix BM may be disposed over the liquid crystal layer.

A first electrode EL1 corresponding to a pixel area which displays an image is formed on the color filter CF (S100). The first electrode EL1 may have silt patterns. The first electrode EL1 may be formed by disposing a first electrode conductive layer and pattering the first electrode conductive layer such as by using photo lithography. The first electrode EL1 may include a transparent conductive material, such as ITO, IZO, etc.

The first insulation layer 200 is formed on the color filter CF and on the first electrode EL1 (S200). The first insulation layer 200 may include an inorganic insulating material such as silicon oxide (SiOx) and silicon nitride (SiNx).

Referring to FIG. 5B, forming a sacrificial layer (S300) will be explained, hereinafter.

A sacrificial layer 300 is formed on the first insulation layer 200. The sacrificial layer 300 corresponds to the pixel area.

A portion of the sacrificial layer 300 will be subsequently removed to form a tunnel-shaped cavity, so that the sacrificial layer 300 has width and height corresponding to that of a liquid crystal layer 320 (refer to FIG. 2 and FIG. 3).

The sacrificial layer 300 includes a positive photoresist. The positive photoresist may be any of a number of positive photoresists suitable for the purpose describe herein. The positive photoresist may include an organic material having novolac resin, but is not limited thereto. In one exemplary embodiment, for example, the sacrificial layer 300 may include positive novolac photoresist. The sacrificial layer 300 may be formed by a deposition process, an ashing process, or a deposition and polishing process. Additionally or alternatively, the sacrificial layer 300 may be formed by an inkjet process, a spin coating process, etc.

Referring to FIG. 5C, forming a second insulation layer (S400) and forming a second electrode (S500) will be explained, hereinafter.

A second insulation layer 400 is formed on the sacrificial layer 300 (S400). The second insulation layer 400 may include an inorganic insulating material such as silicon oxide (SiOx) and silicon nitride (SiNx).

The second electrode EL2 corresponding to the pixel area is formed on the second insulation layer 400 (S500). The second electrode EL2 may include a transparent conductive material, such as ITO, IZO, etc.

Referring to FIG. 5D, forming a protecting layer (S600) will be explained, hereinafter.

A protecting layer 500 is formed on the second insulation layer 400 and on the second electrode EL2. The protecting layer 500 is not formed at an area corresponding to a developer inlet used to remove the sacrificial layer 300, so that a portion of the second insulation layer 400 is exposed. The protecting layer 500 covers substantially an entire of the second insulation layer 400 and the second electrode EL2 except for a location of the developer inlet to protect elements that are not removed during subsequent processes. The protecting layer 500 may include a negative photoresist. The negative photoresist may be any of a number of negative photoresists suitable for the purpose described herein. The negative photoresist may include an organic material having acrylic resin, but is not limited thereto. In one exemplary embodiment, for example, the protecting layer 500 may include a negative acryl photoresist. In addition, the protecting layer 500 may further include a light curable material and/or a thermal curable material.

Referring to FIG. 5E, exposing the formed electrode and layers to light (S700) will be explained, hereinafter.

An entire of the protecting layer 500 and the sacrificial layer 300 is exposed to light, otherwise referred to as entire surface exposure, as indicated by the downward arrows in FIG. 5E. The protecting layer 500 including the negative photoresist is hardened by the entire surface exposure.

The second electrode EL2 and the second insulation layer 400 are transparent, so that the light passes through the second electrode EL2 and the second insulation layer 400. Thus, the light may reached the sacrificial layer 300 by the entire surface exposure. As the light reaches the sacrificial layer 300, dissolution of the sacrificial layer 300 including the positive photoresist may be accelerated, so that the sacrificial layer 300 may be removed by a developer.

A power of the light for the entire surface exposure may be about 300 millijoules (mJ) to about 3 joules (J). In addition, a wavelength of the light may be about 365 nanometers (nm).

Referring to FIG. 5F, forming a developer inlet (S800) will be explained, hereinafter.

A portion of the second insulation layer 400 is exposed by the protecting layer 500 between the adjacent pixel areas. The exposed second insulation layer 400 is etched to remove the exposed portion of the second insulation layer 400 and form the developer inlet. The developer inlet may be defined between portions of the remaining second insulation layer 400. The protecting layer 500 works as a mask, so that the exposed portion of the second insulation layer 400 corresponding to the developer inlet may be etched. A portion of the sacrificial layer 300 is exposed by removing the exposed portion of the second insulation layer 400. Although forming the developer inlet (S800) is performed after exposing the formed electrodes and layers to light (S700) in the illustrated exemplary embodiment, forming the developer inlet (S800) may be performed before exposing the formed electrodes and the layers to light (S700).

Referring to FIG. 5G, removing the sacrificial layer (S900) will be explained, hereinafter.

A developer is injected into the sacrificial layer 300 through the developer inlet, for example, at the exposed portion of the sacrificial layer 300. The developer removes the sacrificial layer 300. By exposing the sacrificial layer 400 to light (S700), the sacrificial layer 300 is changed to a removable state by the developer, so that the sacrificial layer 300 may be easily removed by the developer. In addition, the protecting layer 500 is hardened due to the exposure to light (S700), so that the protecting layer 500 may not be removed by the developer during removal of the sacrificial layer 300. Thus, the developer removes the sacrificial layer 300, so that a tunnel-shaped cavity is formed where the sacrificial layer 300 was disposed.

The developer may include aqueous alkaline solution. In one exemplary embodiment, for example, the developer may include more than about 90% of water and less than about 10% of alkali material. That is, the developer is designed to as to not damage other elements of the display panel while being especially effective for processing the sacrificial layer 300. In addition, the developer may include about 0.4% of tetramethylammonium hydroxide (“TMAH”), about 2.38% of TMAH) or about 1% of potassium hydroxide (“KOH”).

Removing the sacrificial layer (S900) may be performed at about 23 degree Celsius (° C.) to about 26° C. In addition, removing the sacrificial layer (S900) may be performed at specific temperature which can promote a reaction of the sacrificial layer 300 and the developer, but not damage to other elements. In one exemplary embodiment, for example, the specific temperature may be about 23° C. to 80° C.

Referring to FIG. 5H, forming a liquid crystal layer (S1000) will be explained, hereinafter.

An alignment film 310 is formed inside of the tunnel-shaped cavity where the sacrificial layer 300 was previously disposed. Thus, the alignment film 310 is formed on the first insulation layer 200 and below the second insulation layer 400. The alignment film 310 may include an alignment solution. The alignment solution may be a mixture of alignment material such as polyimide, and solvent. The alignment solution is fluid, so that the alignment solution adjacent to the tunnel-shaped cavity may be moved into the tunnel-shaped cavity by capillarity. In one exemplary embodiment, for example, the alignment solution may be injected into the tunnel-shaped cavity through the developer inlet.

The alignment solution may be provided to the tunnel-shaped cavity by an inkjet process such as by using a micropipette or vacuum injection device. After that, the solvent is removed. The substrate 100 may be heated or be in room temperature to remove the solvent.

The alignment film 310 may be omitted according to a type of the liquid crystal layer and/or shapes of the first and second electrodes EL1 and EL2. In one exemplary embodiment, for example, where the first and second electrodes EL1 and EL2 are patterned in specific shape, the alignment film 310 may be omitted.

A liquid crystal layer 320 is formed in the tunnel-shaped cavity including the alignment film 310. The liquid crystal layer 320 may include liquid crystal. The liquid crystal is fluid, so that that the liquid crystal initially adjacent to or just outside of the tunnel-shaped cavity may be moved into the tunnel-shaped cavity by capillarity. In one exemplary embodiment, for example, the liquid crystal may be injected into the tunnel-shaped cavity through the developer inlet, such as between portions of the alignment film 310.

The liquid crystal layer 320 may be provided to the tunnel-shaped cavity by an inkjet such as by using a micropipette or vacuum injection device. In using the vacuum injection device, an opening which exposes the tunnel-shaped cavity is immersed into a container which receives the liquid crystal, and since the pressure of a chamber including the container may be lower, the liquid crystal may move into the tunnel-shaped cavity by capillarity.

Although the liquid crystal layer 320 is formed in the tunnel-shaped cavity in the illustrated exemplary embodiment, an image displaying layer displaying an image may be formed in the tunnel-shaped cavity. In one exemplary embodiment, for example, the image displaying layer may be an electrophoresis layer. Thus, the electrophoresis layer including an insulating medium and charged particles may be formed in the tunnel-shaped cavity.

Referring to FIG. 5I, sealing the developer inlet (S1100) will be explained, hereinafter.

A sealing part 600 seals the developer inlet. The sealing part 600 seals the developer inlet through which the developer, the alignment solution and the liquid crystal are injected. Thus, an upper surface of the display panel is planarized by the protecting layer 500 and the sealing part 600, so that the upper surface of the display panel may be protected.

The sealing part 600 may include an organic material. In one exemplary embodiment, for example, the sealing part 600 may be a sealant.

Referring to FIG. 5J, a lower polarizer 710 is attached under the substrate 100, and an upper polarizer 720 is attached on the protecting layer 500. In one exemplary embodiment, as the upper polarizer 720 is attached to the protecting layer 500, the sealing part 600 may be pressed, so that the sealing part 600 may be deformed to coincide to a surface of the protecting layer 500 such that the upper surface of the display panel is planarized by the protecting layer 500 and the sealing part 600.

In an exemplary embodiment, the method may include a first thermal curing process. The first thermal curing process is performed after forming the protecting layer (S600) and before removing the sacrificial layer (S900).

Referring to FIG. 5D, for example, in the first thermal curing process, the protecting layer 500 is heated to cure the protecting layer 500. The first thermal curing process may be performed at about 130° C. The protecting layer 500 may include a heat-curing material. The first thermal curing process is performed in a specific temperature range such that the sacrificial layer 300 is not thermally cured, because the first thermal curing process is designed for thermal curing of the protecting layer 500. In one exemplary embodiment, for example, the first thermal curing process may be performed at about 80° C. to about 180° C.

In an exemplary embodiment, the method may include a second thermal curing process. The second thermal curing process is performed after removing the sacrificial layer (S900).

Referring again to FIG. 5G, for example, in the second thermal curing process, the protecting layer 500 is heated to cure the protecting layer 500. The second thermal curing process may be performed at about 230° C. The protecting layer 500 may include a heat-curing material. The second thermal curing process may be a secondary thermal curing of the protecting layer 500 after the first thermal curing process. In the second thermal curing process, the sacrificial layer (refer to 300 of FIG. 4F) is already removed, so that the protecting layer 500 may be heated to sufficient temperature without damaging the sacrificial layer. In one exemplary embodiment, for example, the second thermal curing process may be performed at about 180° C. to 300° C.

Because an upper surface of the protecting layer 500 is exposed during the second thermal curing process, although the protecting layer 500 is inflated or deformed by heating, the display panel may be structurally stable.

In an exemplary embodiment, the method may further include forming an upper protecting layer (not shown). Forming the upper protecting layer is performed after sealing the developer inlet (S1100).

The upper protecting layer may be formed on the protecting layer 500 and the sealing part 600. The upper protecting layer may include an inorganic insulating material such as silicon oxide (SiOx) and silicon nitride (SiNx) to protect the upper surface of the display panel.

According to the one or more exemplary embodiment of the invention, a display panel includes a liquid crystal layer in a tunnel-shaped cavity, so that an amount of liquid crystal and the number of substrates may be decreased. That is, a display panel including the liquid crystal layer includes only one substrate, since the liquid crystal layer is maintained within the tunnel-shaped cavity.

In addition, a sacrificing layer and a protecting layer are used to define the tunnel-shaped cavity. Since the sacrificing layer includes a positive photoresist and the protecting layer includes a negative photoresist, the process of manufacturing the display panel may be simplified.

In addition, a top surface of the protecting layer is exposed during a heat curing process, so that an upper surface of the display panel may be planarized and a top surface of the display panel is stable during the heat curing process.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A display panel comprising:
a substrate comprising a plurality of pixel areas;
a thin film transistor on the substrate;
a first electrode electrically connected to the thin film transistor;
a first insulation layer covering the first electrode;
an image displaying layer disposed on the first insulation layer;
a second insulation layer disposed on the image displaying layer;
a second electrode disposed on the second insulation layer and insulated from the first electrode; and
a protecting layer disposed on the second electrode, surrounding a portion of an upper and a side surface of the image displaying layer, and comprising a light curable material.

2. The display panel of claim 1, wherein the first insulation layer and the second insulation layer comprises an inorganic insulating material.

3. The display panel of claim 1, further comprising a sealing part disposed between adjacent pixel areas, and
wherein the sealing part contacts the first insulation layer, the side surface of the image displaying layer, and a side surface of the protecting layer.

4. The display panel of claim 3, further comprising:
a signal line connected to the thin film transistor; and
a black matrix which overlaps the signal line and blocks light,
wherein the sealing part overlaps the black matrix.

5. The display panel of claim 1, wherein the image displaying layer comprises:
a liquid crystal layer comprising liquid crystal, and
an alignment layer disposed between the first insulation layer and the liquid crystal layer, and between the second insulation layer and the liquid crystal layer.

6. The display panel of claim 1, further comprising an upper polarizer disposed on the protecting layer and a lower polarizer disposed under the substrate,
wherein the upper polarizer contacts the protecting layer.

7. A method of manufacturing a display panel, the method comprising:
providing a thin film transistor on a substrate, and providing a first insulation layer disposed on the thin film transistor;
providing a sacrificial layer on the first insulation layer by coating a first photoresist composition;
providing a second insulation layer on the sacrificial layer;
providing a protecting layer on the second insulation layer by coating a second photoresist composition;
exposing the protecting layer and the sacrificial layer to light;
removing the sacrificial layer using a developer to form a space; and
providing an image displaying layer in the space.

8. The method of claim 7, wherein the light has a power of about 300 millijoules to about 3 joules.

9. The method of claim 7, wherein the light has a wavelength of more than about 365 nanometers.

10. The method of claim 7, wherein the developer comprises tetramethylammonium hydroxide or potassium hydroxide.

11. The method of claim 10, wherein the developer comprises:
more than about 90% of water, and
less than about 10% of the tetramethylammonium hydroxide or the potassium hydroxide, respectively.

12. The method of claim 7, wherein the removing the sacrificial layer is performed at a temperature of about 23 degrees Celsius to about 26 degrees Celsius.

13. The method of claim 7, further comprising heating the sacrificial layer in a first thermal curing process before the removing the sacrificial layer, and at a temperature of about 80 degrees Celsius to about 180 Celsius.

14. The method of claim 7, further comprising heating the protecting layer in a second thermal curing process after the removing the sacrificial layer, and at a temperature of about 180 degrees Celsius to about 300 degrees Celsius.

15. The method of claim 7, further comprising:
providing a first electrode on the substrate before the providing the first insulation layer; and
providing a second electrode on the second insulation layer before the providing the protecting layer.

16. The method of claim 7, further comprising providing a developer inlet before the removing the sacrificial layer,
wherein the providing the developer inlet comprises etching an exposed portion of the second insulation layer by using the protecting layer as a mask, to expose the sacrificial layer.

17. The method of claim 7, wherein the first photoresist composition comprises a positive photoresist.

18. The method of claim 17, wherein the second photoresist composition comprises a negative photoresist.

19. The method of claim 7, wherein
the substrate comprises a plurality of pixel areas which display an image,
the sacrificial layer corresponds to the pixel areas, and
the sacrificial layer of a pixel area is spaced apart from the sacrificial layer of an adjacent pixel area.

20. The method of claim 7, wherein the providing the image displaying layer comprises:
providing an alignment film inside of the space, and
providing a liquid crystal layer by injecting liquid crystal into the space and on the alignment film.
